(19) United States
(12) Patent Application Publication
(10) Pub. No.: US 2002/0114048 A1
(43) Pub. Date: Aug. 22, 2002

(54) Apparatus and method for attaching a data sub-channel to a digital payload

(76) Inventor: Matthew D. Brown, Kinburn (CA)

Correspondence Address: Cowling Lafleur Henderson LLP, Suite 2600, 160 Elgin Street, Otawa, ON, K1P 1C3, CA

(21) Appl. No.: 10/004,795

(22) Filed: Dec. 7, 2001

(30) Foreign Application Priority Data
Aug. 12, 2000 (CA) 2,327,906

(51) Int. Cl. H04B 10/04

(52) U.S. Cl. 359/183; 359/181

(57) ABSTRACT

An apparatus and method is disclosed for attaching a data sub-channel to a digital payload data stream having a clock signal for communicating supplemental data within an optical communications network. At an upstream site the clock signal is phase-modulated with an encoded supplemental data stream to generate a phase-modulated sub-channel. The phase-modulated clock is used to time the payload data stream so as to superimpose the phase-modulated sub-channel onto the payload data stream. At a downstream site the sub-channel is recovered and the clock signal is used to retime the payload data stream. The sub-channel is then demodulated and the supplemental data stream decoded.

### FIELD OF THE INVENTION

The present invention relates to an optical communications network, and more specifically to an apparatus and method for attaching a data sub-channel to a digital payload for communicating supplemental data.

### BACKGROUND OF THE INVENTION

Operating today's optical communications networks requires the association of maintenance information with a payload signal as the payload signal enters the network so that it may be monitored as it passes through the network. This maintenance information, or overhead information as it is known, comprises content such as signalling data, provisioning data, and synchronization data used to maintain network integrity.

Overhead information is typically communicated by transmitting a maintenance channel over the data link. One method for transmitting a maintenance channel has a pilot tone attached to wavelengths outside of the data band. This method is separable in that the associated channel cannot transcend digital circuits where only two discrete levels are permitted.

A second method utilizes separate data channels to transmit the overhead information. This method is inefficient in that a new physical channel is required, drawing upon limited resources, unacceptable in resource starved implementations.

Still a third method is to embed the communication channel within the data stream, as is the case with Plesiochronous Digital Hierarchy (PDH), Synchronous Optical Networking/Synchronous Digital Hierarchy (SONET/SDH), and other telecommunication protocols. This method requires the use of embedded or intrinsic information which is, by definition, non-transparent. Bits would have to be modified or functionality would be limited and a unique means would be required for every protocol type carried by the network. Since, in emerging optical networks a variety of telecommunication protocols must be carried, adding extra information using this method would require large investments in digital processing and clock generation infrastructure.

For the foregoing reasons, there is a need for a method of transmitting overhead information and other supplemental data by network elements within optical communications networks that does not affect the contents of the payload data, is inseparable from the payload signal, and is economical.

### SUMMARY OF THE INVENTION

The present invention is directed to a method and apparatus for communicating supplemental data within an optical communications network transmitting a digital payload data stream. The invention comprises transmitting supplemental data by generating a data sub-channel comprising a supplemental data stream and attaching the sub-channel to the digital payload data stream forming a phase-modulated payload data stream at an upstream site.

Generating the sub-channel comprises driving the phase of a phase-modulator using the supplemental data stream to form a phase-modulated sub-channel and phase-modulating a clock signal contained in the payload data stream using the phase-modulator.

Attaching the sub-channel to the digital payload data stream comprises re-timing the payload data stream using the phase-modulated clock signal forming a phase-modulated payload data stream.

In an aspect of the invention, the method comprises a supplemental data being recovered by extracting a supplemental data stream from a recovered phase-modulated payload data stream at a downstream site. Extracting the supplemental data stream from the recovered phase-modulated payload data stream comprises recovering the phase-modulated payload data stream retiming the payload data stream using the recovered clock signal and extracting the supplemental data stream from the recovered phase-modulated payload data stream.

In an aspect of the invention, extracting of the supplemental data from the recovered phase-modulated payload data stream comprises extracting the supplemental data stream using a clock and data recovery circuit having a phase-locking oscillation circuit and retiming the payload data stream using the recovered clock signal.

In an aspect of the invention, the method comprises the supplemental data stream being encoded prior to phase-modulating the clock signal and decoded after extraction.

In an aspect of the invention, the method comprises a supplemental data being transmitted by modulating the phase of a payload data stream and superimposing a supplemental data stream onto the phase-modulated payload data stream forming a phase-modulated payload data stream.

In an aspect of the invention, the method comprises recovering supplemental data by recovering a phase-modulated payload data stream and demodulating a supplemental data stream from the recovered phase-modulated payload data stream. The extracted supplemental data stream may be decoded.

In an aspect of the invention, the method comprises the supplemental data stream being encoded prior to superimposition and decoded after extraction.

In an aspect of the invention, the apparatus comprises a phase-modulator driven by a supplemental data stream for phase-modulating a clock signal of a digital payload data stream whereby a phase-modulated sub-channel is generated and a data re-time circuit for re-timing the payload data stream using the phase-modulated clock signal forming a phase-modulated payload data stream at an upstream site. The supplemental data stream may be encoded using an encoder prior to phase-modulating the clock

In an aspect of the invention, the apparatus comprises a receiver for recovering the phase-modulated payload data stream at a downstream site, a data re-time circuit for re-timing the payload data stream using the recovered clock signal and a phase de-modulator for extracting the supplemental data stream from the recovered phase-modulated payload data stream. The extracted supplemental data stream may be decoded using a decoder.

In an aspect of the invention, the apparatus comprises a phase-modulator driven by a supplemental data stream for phase-modulating a clock signal of a digital payload data stream whereby a phase-modulated sub-channel is generated and a data re-time circuit for re-timing the payload data stream using the phase-modulated clock signal forming a phase-modulated payload data stream at an upstream site. The supplemental data stream may be encoded using an encoder prior to phase-modulating the clock

In an aspect of the invention, the apparatus comprises a clock and data recovery circuit having a phase-locking oscillation circuit for extracting the supplemental data stream and a data re-time circuit for re-timing the payload data stream using the recovered clock signal. The extracted supplemental data stream may be decoded using a decoder.

In an aspect of the invention, the apparatus comprises a phase-modulator for modulating the phase of a payload data stream and transmitter for superimposing a supplemental data stream onto the phase-modulated payload data stream. The supplemental data stream may be encoded using an encoder prior to superimposition. The apparatus may comprise a receiver for recovering the phase-modulated payload data stream and a demodulator for demodulating the supplemental data stream from the recovered phase-modulated payload data stream. The extracted supplemental data stream may be decoded using a decoder.

The PMSC makes use of normally existing functions in an optical communications network such as clock recovery. As a result, no additional circuitry is required to recover the PMSC from the payload signal.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is a block diagram overview of an embodiment of the method for attaching a data sub-channel to a digital payload;

FIG. 2 is a block diagram overview of an embodiment of the method for attaching a data sub-channel to a digital payload further comprising encoding and decoding a supplemental data stream;

FIG. 3 is a block diagram overview of an embodiment of the apparatus for attaching a data sub-channel to a digital payload;

FIG. 4 is a block diagram overview of an embodiment of the invention comprising recovering the phase demodulation directly from the phase comparator;

FIG. 5 is a block diagram overview of an embodiment of the apparatus for attaching a data sub-channel to a digital payload further comprising encoding and decoding a supplemental data stream;

FIG. 6 is a block diagram overview of an embodiment of the invention showing an implementation of the phase modulator circuit;

FIG. 7 is a block diagram overview of an embodiment of the invention showing an implementation of the phase modulator circuit;

FIG. 8 is a block diagram overview of an embodiment of the invention showing an implementation of the phase modulator circuit; and

FIG. 9 is a block diagram overview of an embodiment of the invention comprising directly modulating the payload data stream.

### DETAILED DESCRIPTION OF THE PREFERRED EMBODIMENT

As shown in FIG. 1, an embodiment of the method for attaching a data sub-channel to a digital payload comprises superimposing a phase-modulated sub-channel (PMSC) 10 comprising a supplemental data stream 18 onto a digital payload data stream 14.

At an upstream site, the PMSC 10 is generated by driving the phase of a phase-modulator 20 using the supplemental data stream 18 and phase-modulating a clock signal 22 contained in received client data 12 from a previous upstream site using the phase-modulator.

The PMSC 10 is then attached to the digital payload data stream 14 by re-timing the payload data stream 24 using the phase-modulated clock signal so as to transmit the PMSC 10 superimposed onto the payload data stream 14.

The supplemental data stream 18 is then extracted from the PMSC 10 at a downstream site by recovering the PMSC 28, retiming the payload data stream 34 using the recovered clock signal 32 and extracting the supplemental data stream 30 from the recovered PMSC 10.

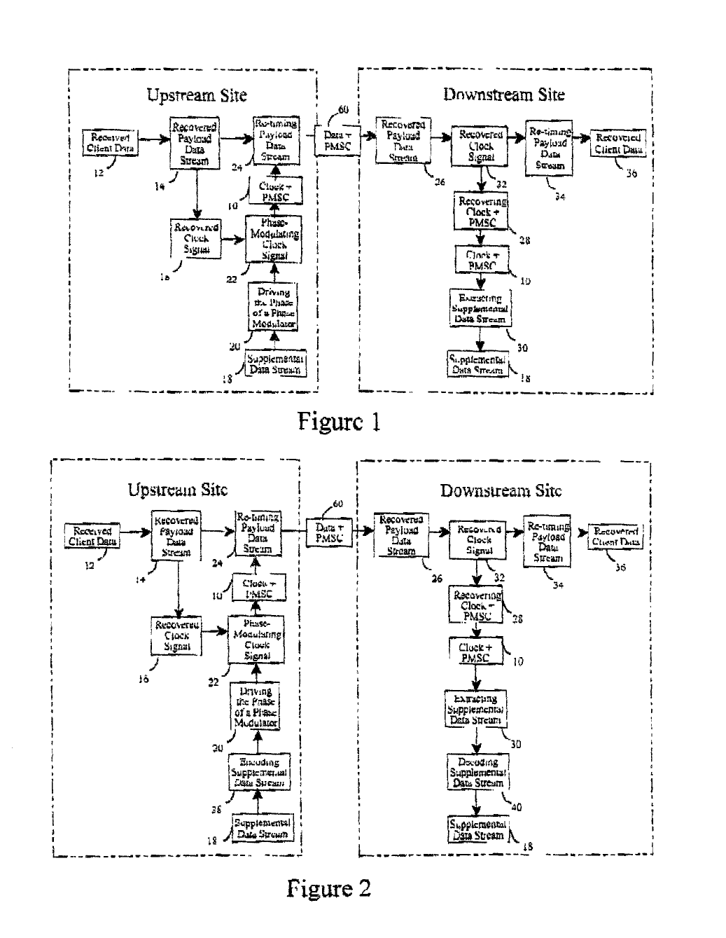

As shown in FIG. 2, the invention may further comprise encoding the supplemental data stream 38 prior to phase-modulating the clock signal and decoding the extracted supplemental data stream 40.

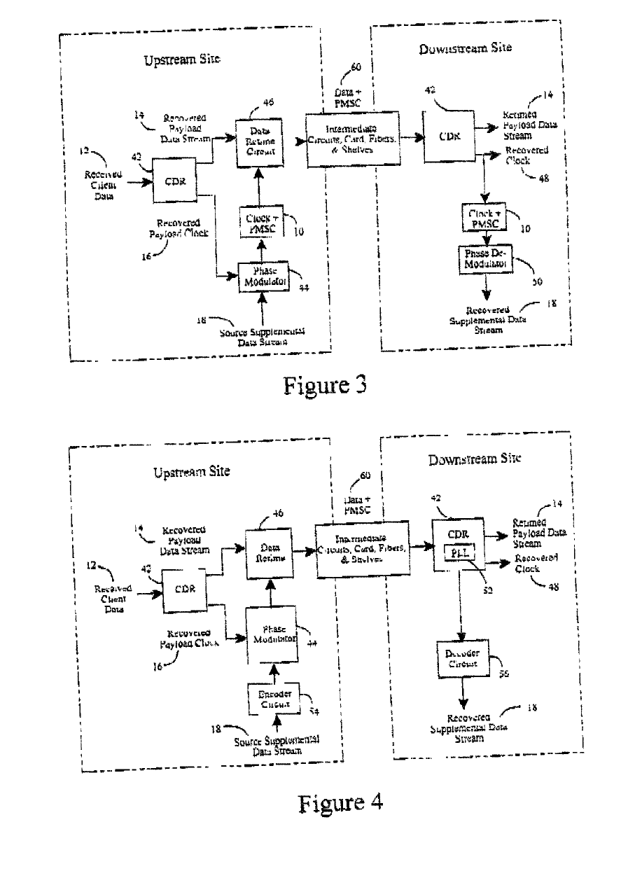

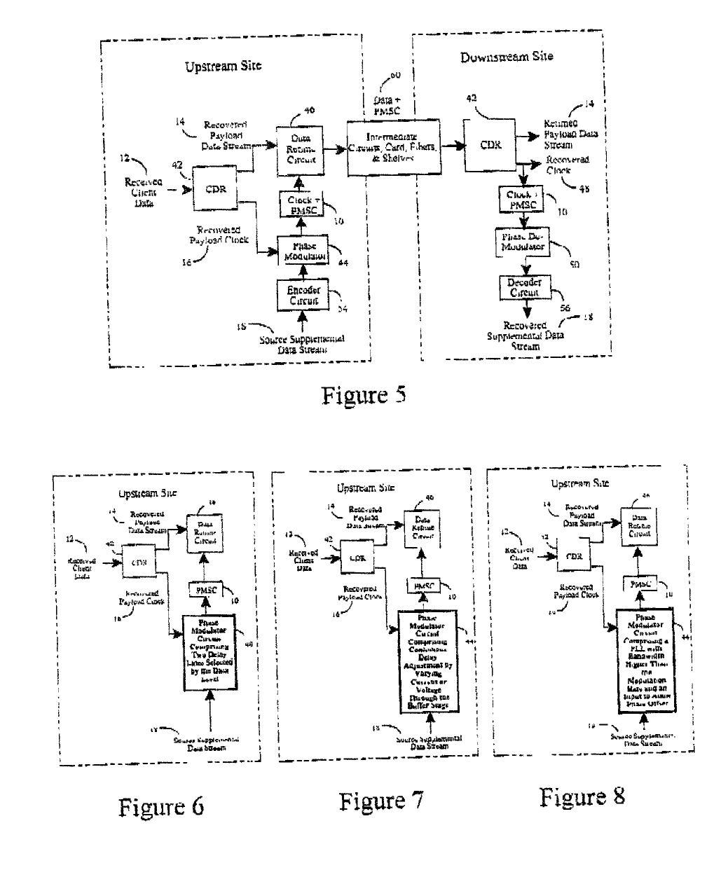

As shown in FIG. 3, an embodiment of the apparatus for attaching a data sub-channel to a digital payload comprises a PMSC 10 superimposed onto a digital payload data stream 14.

At an upstream site, received client data stream 12 from a previous upstream site is recovered by a clock and data recovery circuit (CDR) 42 and a clock 16 is extracted. The supplemental data stream 18 for the PMSC 10 is then used to drive the phase-modulation control of a phase-modulator 44 used to modulate the phase of the extracted clock 16 thereby generating the PMSC 10. The modulated clock is then used to retime the payload data stream 18, typically employing a D-type flip-flop data retime circuit 46 thereby applying the sub-channel modulation to the payload data 14 so as to superimpose the PMSC 10 onto the payload data stream 14.

At a downstream site, the PMSC 10 is recovered from the payload data stream 14 using a CDR 42, whereby the payload data stream 14 is again retimed using the recovered phase-modulated clock 48. A phase demodulator circuit 50 then extracts the supplemental data stream 18 from the recovered clock 48.

As shown in FIG. 4, in an embodiment of the invention, the phase demodulation may be recovered directly from the phase comparator output at the downstream site if the CDR has a phase-locking oscillation circuit (PLL) 52, and the CDR PLL 52 bandwidth is lower than any significant spectral component of the encoded sub-channel.

As shown in FIG. 5, in an embodiment of the invention, the supplemental data stream 18 is first encoded at the upstream site using an encoder circuit 54 with a decoder circuit 56 used to decode the recovered supplemental data stream 18 at the downstream site. The de-coder 56 reversing the encoding process applied at the upstream site.

The PMSC 10 is typically used as an end-to-end or path overhead channel within an optical communications network. The PMSC 10 typically carries path related status information as well as source ID. The PMSC 10 will, by design, manifest itself as jitter and thus reduce the jitter margin, and accordingly the optical power margin on a data link. This, however, will not be a problem as long as the bit rate is low enough that jitter components are trackable by the downstream PLL's 52, such as data rates of less than 12 kHz.

The PMSC 10 may be difficult to recover in low signal-to-noise ratio (SNR) conditions. This will, however, be inconsequential if the data rate is sufficiently low and SNR conditions are reasonable, such as a bit error rate (BER) on the payload of less than 10-10. It should be noted that the same problem will exist with any superimposed sub-channel method.

Recovery of the PMSC 10 may be difficult in long chains of payload regenerators and Erbium Doped Fibre Amplifier/Semiconductor Optical Amplifiers (EDFA/SOA) due to accumulated phase noise. The data rate of the PMSC 10 is limited by the lowest PLL 52 bandwidth in the chain between the phase-modulator 44 and phase demodulator 50. This will be inconsequential however, since regenerator bandwidths are relatively high.

The purpose of the encoder circuit 54 is to add robustness to the supplemental data stream 18, condition the spectral content of the phase so that it is compatible with the payload 14 and the phase noise requirements, improve the ability to recover the data 18 at the far end, and provide a means to assess the performance of the PMSC 10.

The CDR 42 may be implemented in one of many possible manifestations. The purpose of the CDR 42 is to generate a clock 16 which is synchronous with the incoming payload data stream, as well as to center the clock 16 in the middle of the input eye. The clock 16 is then used to retime the payload data stream 14 thereby maximizing noise rejection by avoiding noise near the data edges.

Phase-modulation is impervious to, and thus “transparently” transcends, amplitude non-linearity and multiple data-level regeneration stages such as limiting amps.

The ability to transcend regeneration stages and other network components unaffected by intermediate processing elements such as circuits, cards, fibre and shelves allows a sending element at an upstream site to “talk” directly with a receiving element at a downstream site. The PMSC 10 is always “attached” to the payload signal 14 thereby permitting the sending element to provide source information in the PMSC 10, to be confirmed at the receiving element. Therefore, the PMSC 10 enables confirmation of correct path connectivity, such as end-to-end or path overhead channel.

The PMSC 10 makes use of normally existing functions in an optical communications network such as clock recovery. As a result, no additional circuitry is required to recover the PMSC 10 from the payload signal 14.

There are numerous advantages of the invention with respect to addressing existing shortcomings. The shortcomings being addressed within an embodiment of the invention depend upon the application of the PMSC 10 within that embodiment. The PMSC 10 can be used for any one application, or a combination thereof.

In an embodiment of the invention, the supplemental data stream 18 is phase-modulated using a phase-modulator circuit 44 designed to cause shifts in the phase of the clock 16 proportional to the modulating voltage or PMSC 10. As shown in FIGS. 6, 7 and 8, the phase-modulator circuit 44 may be implemented in a number of ways including, but not limited to, two-delay lines selected by the data level, continuous delay adjustment by varying current or voltage through the buffer stage, or a PLL 52 with bandwidth higher than the modulation rate and an input to allow phase offset.

The phase demodulator 50 may be implemented in one of a number of ways, including using a PLL 52 with a bandwidth smaller than any significant frequency component of the PMSC 10, or using the payload CDR 42 and a frequency discriminator in combination with a peak detector.

Other PMSC 10 content could include a data communications channel, signalling data such as protection handshaking, provisioning data, and/or synchronization reference.

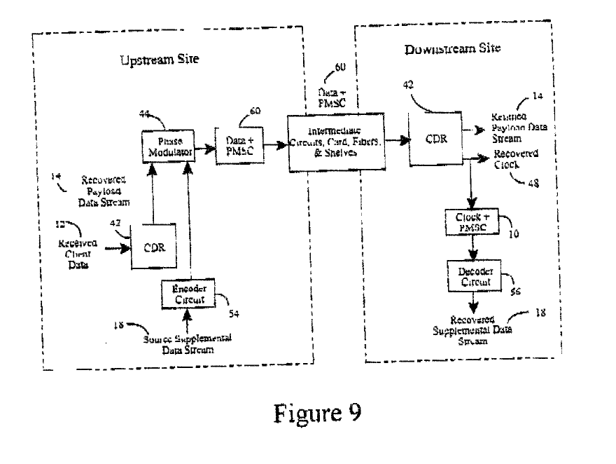

As shown in FIG. 9, the payload data stream 14 at the upstream site may be directly modulated. The sub-channel signal 18 would then be injected into the optical network, superimposed onto the payload data stream 14. However, phase-modulation of the supplemental data stream 18 as described in embodiments of the invention provides for more implementation options and typically results in higher performance.

As shown in FIGS. 1 and 3, in another embodiment of the invention, encoding or sub-modulation of the sub-channel 38 may be omitted if the baseband data is compatible with the payload 14 and phase-modulation method. However, a sub-channel encoder circuit 54 is needed to condition the supplemental data stream 18 in conditions where the baseband is incompatible with the payload 14 and phase-modulation method.

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method for communicating supplemental data within an optical communications network transmitting a digital payload data stream having a clock signal, the method comprising the steps of:
(i) generating a data sub-channel comprising a supplemental data stream; and
(ii) attaching the sub-channel to the digital payload data stream at an upstream site forming a phase-modulated payload data stream.

2. The method according to claim 1, further comprising the steps of:
(i) recovering the phase-modulated payload data stream;
(ii) retiming the payload data stream using the recovered clock signal; and
(iii) extracting the supplemental data stream from the recovered phase-modulated payload data stream.

3. The method according to claim 1, wherein generating the sub-channel comprises:
(i) driving the phase of a phase-modulator using the supplemental data stream to form a phase-modulated sub-channel; and
(ii) phase-modulating the clock signal contained in the payload data stream using the phase-modulator.

4. The method according to claim 1, wherein attaching the sub-channel to the digital payload data stream at an upstream site comprises re-timing the payload data stream using the phase-modulated clock signal forming a phase-modulated payload data stream.

5. The method according to claim 2, wherein the extracting of the supplemental data in the phase-modulated payload data stream at a downstream site comprises:
(i) extracting the supplemental data stream using a clock and data recovery circuit having a phase-locking oscillation circuit; and
(ii) retiming the payload data stream using the recovered clock signal.

6. The method according to claim 3, further comprising encoding the supplemental data stream prior to phase-modulating the clock signal.

7. The method according to claim 2, further comprising decoding the extracted supplemental data stream.

8. A method for communicating supplemental data within an optical communications network transmitting a digital payload data stream having a clock signal, the method comprising:
(i) modulating the phase of a payload data stream; and
(ii) superimposing a supplemental data stream onto the phase-modulated payload data stream.

9. The method according to claim 8, further comprising:
(i) recovering a phase-modulated payload data stream; and
(ii) demodulating a supplemental data stream from the recovered phase-modulated payload data stream.

10. The method according to claim 8, further comprising encoding the supplemental data stream prior to superimposition.

11. The method according to claim 9, further comprising decoding the demodulated supplemental data stream.

12. An apparatus for transmitting supplemental data within an optical communications network transmitting a digital payload data stream having a clock signal, the apparatus comprising:
means for generating a data sub-channel comprising a supplemental data stream; and
means for attaching the sub-channel to the digital payload data stream at an upstream site forming a phase-modulated payload data stream.

13. The apparatus according to claim 12, wherein the means for generating the sub-channel comprises:
means for driving the phase of a phase-modulator using the supplemental data stream to form a phase-modulated sub-channel; and
means for phase-modulating the clock signal contained in the payload data stream using the phase-modulator.

14. The apparatus according to claim 12, wherein the means for attaching the sub-channel to the digital payload data stream at an upstream site comprises means for re-timing the payload data stream using the phase-modulated clock signal so as to transmit a phase-modulated payload data stream.

15. The apparatus according to claim 13, further comprising means for encoding the supplemental data stream prior to phase-modulating the clock signal.

16. An apparatus for receiving supplemental data within an optical communications network transmitting a digital payload data stream having a clock signal, the apparatus comprising:
means for recovering the phase-modulated payload data stream;
means for retiming the payload data stream using the recovered clock signal; and
means for extracting the supplemental data stream from the recovered phase-modulated payload data stream.

17. The apparatus according to claim 16, wherein the means for extracting the supplemental data from the recovered phase-modulated payload data stream at a downstream site comprises:
means for extracting the supplemental data stream using a clock and data recovery circuit having a phase-locking oscillation circuit; and
means for retiming the payload data stream using the recovered clock signal.

18. The apparatus according to claim 16, further comprising means for decoding the extracted supplemental data stream.

19. An apparatus for transmitting supplemental data within an optical communications network transmitting a digital payload data stream having a clock signal, the apparatus comprising:
means for modulating the phase of a payload data stream; and
means for superimposing a supplemental data stream onto the phase-modulated payload data stream.

20. The apparatus according to claim 19, further comprising means for encoding the supplemental data stream prior to superimposition.

21. An apparatus for receiving supplemental data within an optical communications network transmitting a digital payload data stream having a clock signal, the apparatus comprising:
means for recovering a phase-modulated payload data stream; and
means for demodulating the supplemental data stream from the recovered phase-modulated payload data stream.

22. The apparatus according to claim 21, further comprising means for decoding the demodulated supplemental data stream.

23. An apparatus for transmitting supplemental data within an optical communications network transmitting a digital payload data stream having a clock signal, the apparatus comprising:
a phase-modulator driven by a supplemental data stream for phase-modulating the clock signal of the digital payload data stream whereby a phase-modulated sub-channel is generated; and
a data re-time circuit for re-timing the payload data stream using the phase-modulated clock signal so as to form a phase-modulated payload data stream.

24. The apparatus according to claim 23, further comprising encoder for encoding the supplemental data stream prior to phase-modulating the clock signal.

25. An apparatus for receiving supplemental data within an optical communications network transmitting a digital payload data stream having a clock signal, the apparatus comprising:
a receiver for recovering a phase-modulated payload data stream at a downstream site;
a data re-time circuit for re-timing the payload data stream using the recovered clock signal; and
a phase de-modulator for demodulating the supplemental data stream from the recovered phase-modulated payload data stream.

26. The apparatus according to claim 25, further comprising a decoder to decode the demodulated supplemental data stream.

27. An apparatus for receiving supplemental data within an optical communications network transmitting a digital payload data stream having a clock signal, the apparatus comprising:
a clock and data recovery circuit having a phase-locking oscillation circuit for extracting the supplemental data stream; and
a data re-time circuit for re-timing the payload data stream using the recovered clock signal.

28. The apparatus according to claim 27, further comprising a decoder to decode the extracted supplemental data stream.

29. An apparatus for transmitting supplemental data within an optical communications network transmitting a digital payload data stream having a clock signal, the apparatus comprising:
a phase-modulator for modulating the phase of a payload data stream; and
a transmitter for superimposing a supplemental data stream onto the phase-modulated payload data stream.

30. The apparatus according to claim 29, further comprising an encoder for encoding the supplemental data stream prior to superimposition.

31. An apparatus for receiving supplemental data within an optical communications network transmitting a digital payload data stream having a clock signal, the apparatus comprising:
a receiver for recovering a phase-modulated payload data stream; and
a demodulator for demodulating a supplementary data stream from the recovered phase-modulated payload data stream.

32. The apparatus according to claim 31, further comprising a decoder to decode the demodulated supplemental data stream.
